(19) United States
(12) Patent Application Publication
(10) Pub. No.: US 2026/0131347 A1
(43) Pub. Date: May 14, 2026

(54) INTEGRATED ROBOTIC DISPENSE SYSTEM AND METHOD

(71) Applicant: GM GLOBAL TECHNOLOGY OPERATIONS LLC, Detroit, MI (US)

(72) Inventors: Dalong Gao, Rochester, MI (US); Albert Chen, Troy, MI (US); Prateek Mishra, Rochester, MI (US); Ryan C.R. Gergely, Fraser, MI (US); John P. Spicer, Plymouth, MI (US); Joseph K. Williams, Washington Twp, MI (US)

(73) Assignee: GM GLOBAL TECHNOLOGY OPERATIONS LLC, Detroit, MI (US)

(21) Appl. No.: 18/946,003

(22) Filed: Nov. 13, 2024

(51) Int. Cl. B05C 5/02; B05C 11/10; B25J 11/00

(52) U.S. Cl. CPC B05C 5/0225; B05C 11/1005; B25J 11/0075

(57) ABSTRACT

An integrated robotic dispense system for dispensing a bead of viscous material onto a workpiece according to a bead layout pattern includes a robot subsystem including a robot, a dispensing subsystem including a dispenser attached to a working end of the robot for dispensing the viscous material, and a control subsystem including a robot subsystem control module for moving the working end according to a motion profile, a dispensing subsystem control module for controlling the dispensing according to a dispense profile, and a central control module connected with the subsystem control modules. The central control module is configured for determining the motion and dispense profiles, and for causing the robot subsystem to be moved according to the motion profile and the dispensing subsystem to dispense according to the dispense profile to form a dispensed bead, such that a deviation is minimized between the dispensed bead and the bead layout pattern.

### INTRODUCTION

This disclosure relates generally to integrated robotic dispense systems and methods for dispensing a bead of viscous material onto a workpiece according to a bead layout pattern.

In many manufacturing applications, a viscous material such as an adhesive or sealant is dispensed onto a workpiece (or between two adjacent or abutted workpieces) so as to adhere or seal the workpieces. In cases where such dispensing is automated, and even in cases where the dispensing is done manually by human operators, it is often the case that a dispense pattern is established along which the viscous material is to be dispensed.

However, oftentimes the actual dispensed bead of viscous material does not quite conform to the intended bead layout pattern. For example, the bead size or width may unintentionally vary along the bead's length, causing some areas where the bead width is too wide (thus wasting the viscous material) and other areas where the bead width is too narrow (thus potentially compromising the intended adhesion or sealing of the workpieces).

### SUMMARY

According to one embodiment, an integrated robotic dispense system for dispensing a bead of viscous material onto a workpiece according to a bead layout pattern includes: (i) a robot subsystem which includes a robot, wherein the robot has a base and a series of one or more articulatable arms having a base end attached to the base and a working end opposite the base end; (ii) a dispensing subsystem which includes a dispenser operatively attached to the working end and configured to selectably dispense the viscous material from a dispenser tip; and (iii) a control subsystem which includes a robot subsystem control module operatively connected with the robot subsystem for moving and positioning the one or more arms and the working end according to a motion profile, a dispensing subsystem control module operatively connected with the dispensing subsystem for controlling the dispensing of the viscous material by the dispenser according to a dispense profile, and a central control module operatively connected with the robot subsystem control module and the dispensing subsystem control module. The central control module is configured for determining the motion profile and the dispense profile and for causing the robot subsystem to be moved and positioned according to the motion profile and the dispensing subsystem to dispense the viscous material according to the dispense profile to form a dispensed bead, such that a deviation is minimized between the dispensed bead and the bead layout pattern.

The central control module may determine the motion profile and the dispense profile based on the bead layout pattern and one or more of: one or more material properties of the viscous material; one or more material properties of the workpiece; one or more geometric or surface features of the workpiece; one or more limitations of the robot subsystem; one or more limitations of the dispensing subsystem; one or more environmental factors; and machine learning based on data relating to previous instances of dispensing the viscous material. The central control module may be further configured to modify one or both of the motion profile and the dispense profile in order to cause the bead to conform with the bead layout pattern. Additionally, at least one of the motion profile and the dispense profile may be modified due to a direction change in the bead layout pattern.

The integrated robotic dispense system may further include one or more sensors for monitoring the deviation between the bead layout pattern and the dispensed bead, and the central control module may be further configured to modify one or both of the motion profile and the dispense profile when the deviation is larger than a maximum allowable deviation.

The dispensing subsystem may further include a chamber for containing the viscous material, and the dispenser tip may be in fluid communication with the chamber.

The dispensing subsystem may further include a material reconditioner configured for altering a material property of the viscous material. The material property may be viscosity, and the material reconditioner may be configured for applying shear to the viscous material so as to reduce the viscosity thereof.

The viscous material may be one of an adhesive, a sealant, a mastic and a molten metal.

The motion profile may define one or more motions for one or more of the working end and the one or more arms for achieving a respective position and orientation for the one or more of the working end and the one or more arms, and the dispense profile may define one or more dispense starts, one or more dispense stops and one or more dispense flow rates for the dispensing of the viscous material by the dispenser.

The bead layout pattern may be defined with respect to a spatial position and a spatial orientation of the workpiece. Additionally or alternatively, the bead layout pattern may be defined with respect to one or more surface features of the workpiece.

The bead layout pattern may include one or more of: a respective start point, stop point and straight path for each of one or more straight bead segments; a respective begin point, end point and curved path for each of one or more curved bead segments; and a respective bead width for every point along each of the one or more straight bead segments and each of the one or more curved bead segments.

According to another embodiment, an integrated robotic dispense system for dispensing a bead of viscous material onto a workpiece according to a bead layout pattern includes: (i) a robot subsystem which includes a robot, wherein the robot has a base and a series of one or more articulatable arms having a base end attached to the base and a working end opposite the base end; (ii) a dispensing subsystem which includes a dispenser operatively attached to the working end and configured to selectably dispense the viscous material from a dispenser tip; and (iii) a control subsystem which includes a robot subsystem control module operatively connected with the robot subsystem for moving and positioning the one or more arms and the working end according to a motion profile, a dispensing subsystem control module operatively connected with the dispensing subsystem for controlling the dispensing of the viscous material by the dispenser according to a dispense profile, and a central control module operatively connected with the robot subsystem control module and the dispensing subsystem control module. The central control module is configured for: (a) determining the motion profile and the dispense profile based on the bead layout pattern; (b) causing the robot subsystem to be moved and positioned according to the motion profile and the dispensing subsystem to dispense the viscous material according to the dispense profile to form a dispensed bead, such that the robot subsystem and the dispensing subsystem cooperate together to minimize a deviation between the bead layout pattern and the dispensed bead; and (c) modifying one or both of the motion profile and the dispense profile when the deviation is larger than a maximum allowable deviation.

In this embodiment, the central control module may determine the motion profile and the dispense profile based further on one or more of: one or more material properties of the viscous material; one or more material properties of the workpiece; one or more geometric or surface features of the workpiece; one or more limitations of the robot subsystem; one or more limitations of the dispensing subsystem; one or more environmental factors; and machine learning based on data relating to previous instances of dispensing the viscous material.

In this embodiment, at least one of the motion profile and the dispense profile may be modified due to a direction change in the bead layout pattern.

In this embodiment, the integrated robotic dispense system may further include one or more sensors for monitoring the deviation between the bead layout pattern and the dispensed bead.

In this embodiment, the dispensing subsystem may further include a material reconditioner configured for altering a viscosity of the viscous material.

In this embodiment, the motion profile may define one or more motions for one or more of the working end and the one or more arms for achieving a respective position and orientation, for the one or more of the working end and the one or more arms, and the dispense profile may define one or more dispense starts, one or more dispense stops and one or more dispense flow rates, for the dispensing of the viscous material by the dispenser.

According to yet another embodiment, a method for dispensing a bead of viscous material onto a workpiece according to a bead layout pattern includes: (i) providing an integrated robotic dispense system which includes a robot having a base and a series of one or more articulatable arms having a base end attached to the base and a working end opposite the base end, a dispenser operatively attached to the working end and configured to selectably dispense the viscous material from a dispenser tip, and a control subsystem for moving and positioning the one or more arms and the working end according to a motion profile and controlling the dispensing of the viscous material by the dispenser according to a dispense profile; (ii) determining, by the control subsystem, the motion profile and the dispense profile based on the bead layout pattern; (iii) causing the robot to be moved and positioned according to the motion profile and the dispenser to dispense the viscous material according to the dispense profile to form a dispensed bead; (iv) monitoring a deviation between the bead layout pattern and the dispensed bead; and (v) modifying one or both of the motion profile and the dispense profile when the deviation is larger than a maximum allowable deviation.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1A is a linear dispensed bead pattern, FIG. 1B is a graph of bead width versus linear displacement for the linear dispensed bead pattern of FIG. 1A, and FIG. 1C is a graph of dispenser tip velocity and dispense flow rate versus linear displacement for producing the linear dispensed bead pattern of FIG. 1A, all according to a customary approach.

FIG. 2A is a linear dispensed bead pattern, FIG. 2B is a graph of bead width versus linear displacement for the linear dispensed bead pattern of FIG. 2A, and FIG. 2C is a graph of dispenser tip velocity and dispense flow rate versus linear displacement for producing the linear dispensed bead pattern of FIG. 2A, all produced by utilizing the integrated robotic dispense system and method of the present disclosure.

FIG. 3 is a schematic diagram of an exemplary bead layout pattern.

FIG. 4 is an exploded view of the schematic diagram of FIG. 3.

FIG. 5 is a block diagram of various components of a bead layout pattern.

FIG. 6 is a block diagram of various types of viscous material.

FIG. 7 is a block diagram of various material properties of the viscous material.

FIG. 8 is a close-up view of a portion of the schematic diagram of FIG. 3.

FIG. 9 is a close-up view of FIG. 8, and including a dispensed bead of viscous material.

FIG. 10 is a schematic diagram of an integrated robotic dispense system.

FIG. 11 is a block diagram of inputs into a central control module for producing a motion profile and a dispense profile.

FIG. 12 is a flowchart for a method for dispensing a bead of viscous material onto a workpiece according to a bead layout pattern.

### DETAILED DESCRIPTION

Referring now to the drawings, wherein like numerals indicate like parts in the several views, an integrated robotic dispense system (“IRDS”) 40 and method 100 for dispensing a bead 26 of viscous material 18 onto a workpiece 10 according to a bead layout pattern 27 are shown and described herein.

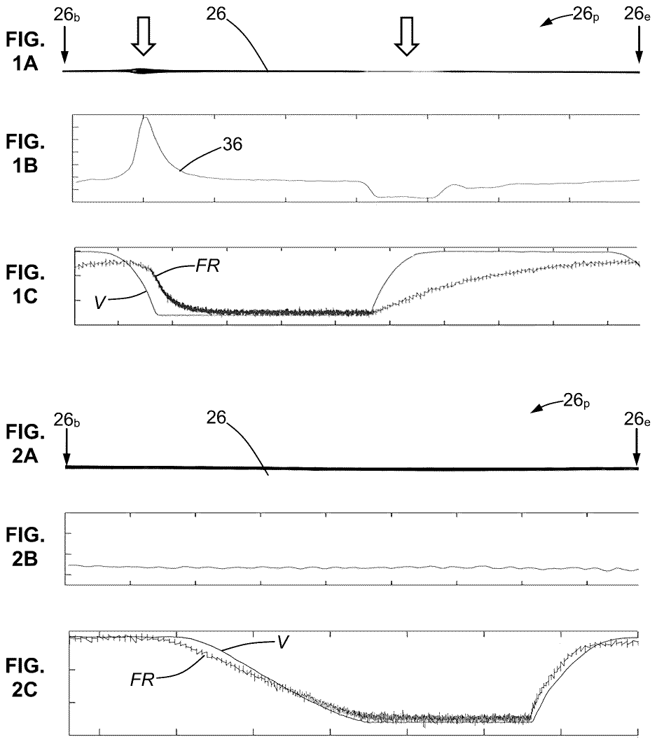

FIG. 1A shows a dispensed bead pattern 26ₚ that is linear in shape (i.e., a straight line) as produced according to a customary approach. Relatedly, FIG. 1B shows a graph of bead width 36 versus linear displacement for the dispensed bead pattern 26ₚ of FIG. 1A, and FIG. 1C shows a graph of dispenser tip velocity V (shown by the thinner curve) and dispense flow rate FR (shown by the thicker, fuzzier curve), both versus linear displacement, for producing the dispensed bead pattern 26ₚ of FIG. 1A. In contrast, FIGS. 2A-C show the same graphics as FIGS. 1A-C, but using the IRDS 40 and method 100 according to the present disclosure.

More specifically, FIG. 1A shows a dispensed bead 26 of viscous material 18 that has been dispensed along a straight line, extending from a beginning point 26_{b} on the left of the graphic to an ending point 26ₑ on the right of the graphic. In the case shown here, the intention is to dispense the viscous material 18 uniformly and with a constant, uniform bead width 36—while the dispenser tip velocity V and dispense flow rate FR are changing—but here the dispensed bead 26 has a couple of areas where the bead width 36 differs by a significant amount from all the other areas of the dispensed bead 26 where the bead width 36 is relatively uniform.

For example, note that FIG. 1A shows two downward-pointing arrows to indicate these two points; the first or leftmost arrow points to a location along the dispense path where the bead width 36 is significantly larger/wider than most of the path (see the peak in the curve of FIG. 1B at this first point), and the second or rightmost arrow points to a different location along the dispense path where the bead width 36 is significantly smaller/narrower than most of the path (see the valley in the curve of FIG. 1B at this second point). Following this first/leftmost arrow down to FIG. 1C, it can be seen that at this area the dispenser tip velocity V sharply decreased while the dispense flow rate FR continued to remain relatively high until after the decline in dispenser tip velocity V, which caused the dispensed bead 26 to be larger/wider here. As for the second/rightmost arrow, it can be seen that at this area the dispenser tip velocity V sharply increased while the dispense flow rate FR only gradually increased, which caused the dispensed bead 26 to be smaller/narrower here, with the overall bead width 36 downstream (i.e., rightward) of the second/rightmost arrow continuing to be significantly narrower than the overall bead width 36 upstream (i.e., leftward) of the first/leftmost arrow.

In contrast, the dispensed bead pattern 26ₚ shown in FIG. 2A appears to be quite uniform in thickness, as also confirmed by the relatively flat and consistent beam width 36 shown in FIG. 2B. As shown in FIG. 2C, the dispenser tip velocity V and the dispense flow rate FR have been manipulated, timed, coordinated and controlled such that the uniform dispended bead 26 has been produced. However, such coordination and cooperation between the dispenser tip velocity V and the dispense flow rate FR has not heretofore been seen in customary approaches.

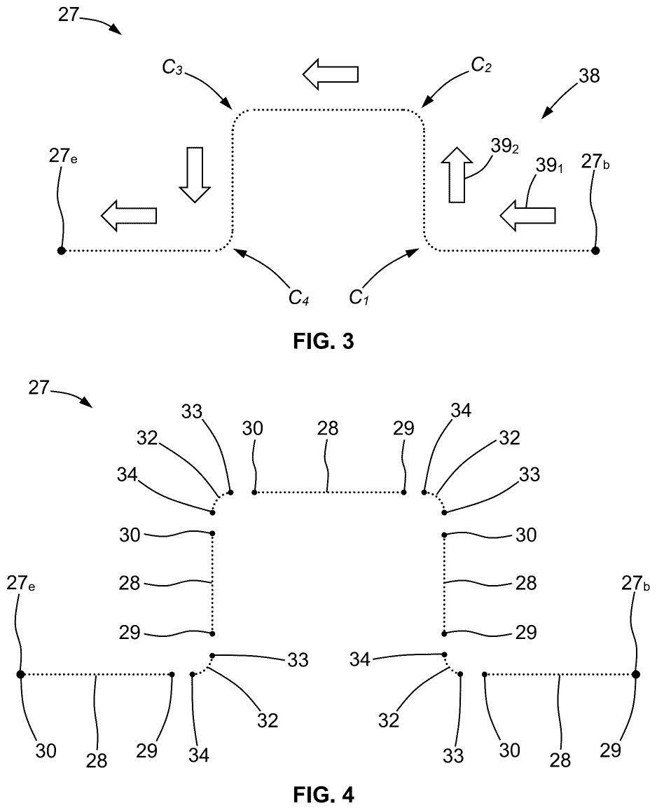

FIG. 3 shows a schematic diagram of an exemplary bead layout pattern 27 or path on a workpiece 10, shown as an undulating dotted line. Here, the bead layout pattern 27 starts at a beginning point 27_{b} and ends at an ending point 27ₑ, with the bead layout pattern 27 initially heading in a first or leftward direction 39₁ toward a first corner C₁, then heading in a second or upward direction 39₂ toward a second corner C₂, then continuing leftward along the first direction 39₁ toward a third corner C₃, followed by turning downward opposite the second direction 39₂ toward a fourth corner C₄, and finally proceeding leftward again in the first direction 39₁ until the ending point 27ₑ is reached.

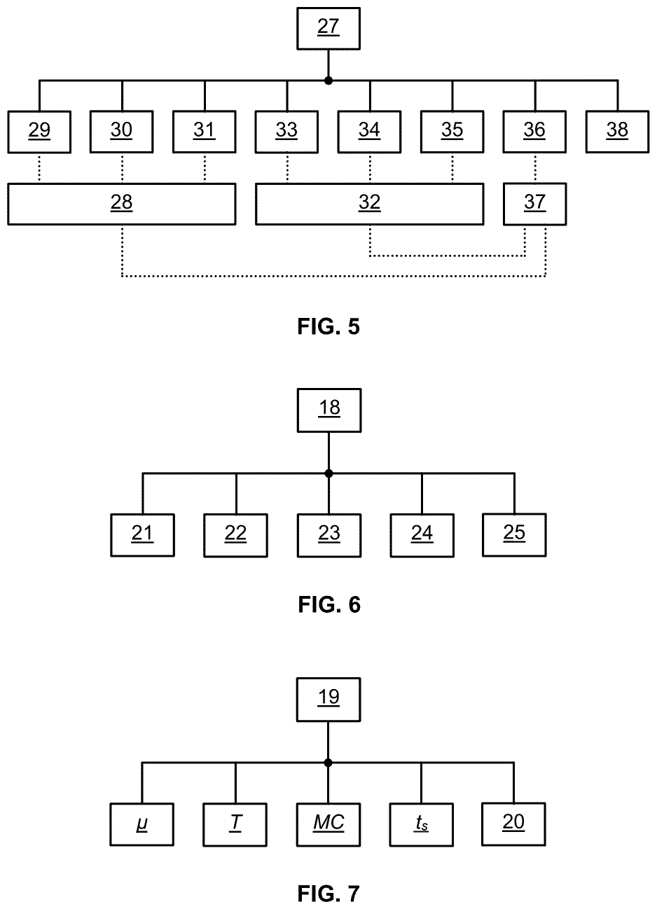

FIG. 4 shows an exploded view of the schematic diagram of FIG. 3, and FIG. 5 shows a block diagram of the various components that make up the bead layout pattern 27. As shown in the drawings, the pattern 27 includes five straight segments 28 with each having a respective start point 29, stop point 30 and straight path 31, and four curved bead segments 32 with each having a respective begin point 33, end point 34 and curved path 35. Each straight or curved bead segment 28, 32 is made up of a finite or infinite number of points 37 along the respective straight or curved path 31, 35, with each point 37 having its own respective bead width 36. As noted above, the bead layout pattern 27 includes four direction changes 38, specifically at each of the four corners C₁, C₂, C₃, C₄.

Once a bead layout pattern 27 has been established for a workpiece 10 (or for two or more adjoining, abutted or closely spaced apart workpieces 10), then a dispensing device may be used to dispense viscous material 18 along and on top of the bead layout pattern 27, thereby producing a dispensed bead 26 arrayed in a dispensed bead pattern 26ₚ. Note that part of the bead layout pattern 27 may include a respective bead width 36 for each point 37 along the bead layout pattern 27. For bead layout patterns 27 that are designed to have a constant, uniform bead width 36, then every point 37 along the bead layout pattern or path 27 would have the same bead width 36, but other bead layout patterns 27 may have a bead width 36 that varies along the length thereof.

Ideally, the overall dispensed bead pattern 26ₚ of the dispensed bead 26 should match the bead layout pattern 27 exactly (or within an acceptable tolerance or variation), including a match between the desired bead width 36 for each point and the actual/dispensed bead width 36 for each point. However, due to variations in the viscous material 18 used—specifically variations in the material properties 19 of the viscous material 18—as well as limitations and variations in the equipment used, etc., the dispensed bead paₚtern 26p might not always adequately match the bead layout pattern 27 when using customary equipment and processes. Such mismatches may be particularly noticeable at corners and transition points in the bead layout pattern 27, where the dispensing rate of the dispensing device and the movements of the dispensing device may not be sufficiently coordinated when customary equipment and processes are used.

FIG. 6 shows a block diagram of various types of viscous material 18 that may be used, and FIG. 7 shows a block diagram of various material properties 19 of these viscous materials 18. As shown in the drawings, the viscous material 18 may be an adhesive 21, a sealant 22, a mastic 23, a molten metal 24 or some other viscous material 25, and the material property 19 may be a viscosity μ, a temperature T, a moisture content MC, a tackiness or stickiness tₛ or any other suitable material property 20.

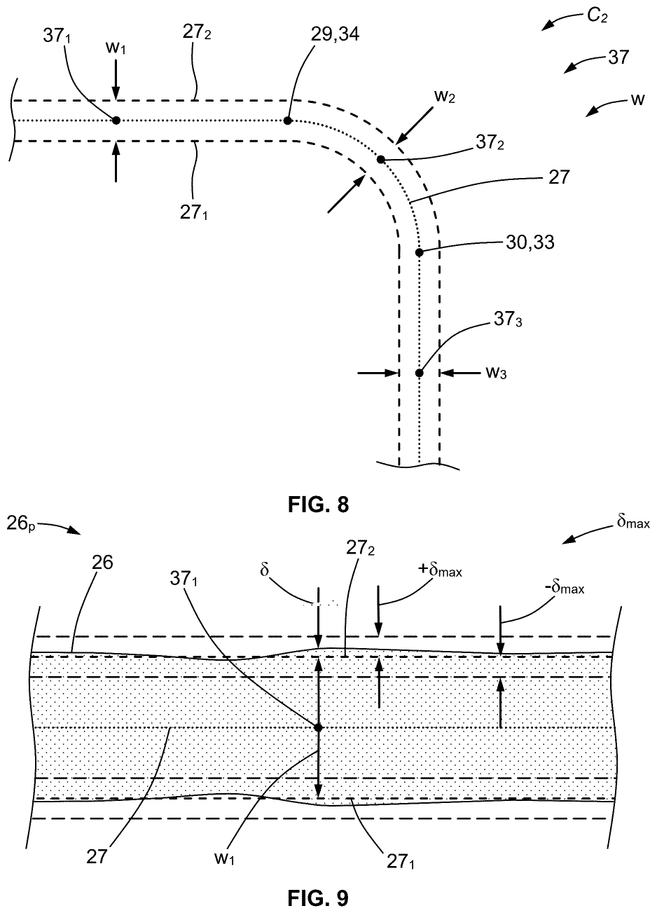

FIG. 8 shows a close-up view of the upper-right portion of the bead layout pattern 27 of FIG. 3, around the second corner C₂. As mentioned above and as shown here, the bead layout pattern 27 is made up of a number of serially contiguous points 37, with the bead layout pattern 27 having a constant or variable bead width 36 therealong. For example, at a first point 37₁ as shown in the drawing, the bead layout pattern 27 has a first width w₁, which extends from a first or inner boundary 37₁ to a second or outer boundary 37₂. Similarly, at a second point 37₂, the bead layout pattern 27 has a second width w₂, and at a third point 37₃, the bead layout pattern 27 has a third width w₃. As illustrated here, the bead layout pattern 27 may have a uniform, constant width w, or the width w may vary along the length of the bead layout pattern 27.

The bead layout pattern 27 may be defined with respect to one or more surface features 12 of the workpiece 10 (e.g., flat surfaces, curved surfaces, positive surface features 13 such as protuberances, ridges and edges, negative surface features 14 such as depressions and holes, etc.), as well as a spatial position 15 and a spatial orientation 16 of the workpiece 10 within three-dimensional (3D) space. As used here, “3D space” which may be defined by three mutually orthogonal axes, (i.e., x, y and z) whose origin is defined at a center of mass/center of gravity of the workpiece 10.

FIG. 9 shows a close-up view of FIG. 8, around the aforementioned first point 37₁. Like FIG. 8, this close-up view includes the bead layout pattern 27 with its first/inner boundary 27₁ and second/outer boundary 27₂ separated from each other by the first width w₁, but also including a dispensed bead 26 of viscous material 18 that has been dispensed on top of the bead layout pattern 27. As shown here, a first or “positive” deviation+δₘₐₓ may be added “outward” from each of the first/inner boundary 27₁ and the second/outer boundary 27₂, and a second or “negative” deviation−δₘₐₓ may be subtracted “inward” from each of the first/inner boundary 27₁ and the second/outer boundary 27₂. This range between the “positive” deviation+δₘₐₓ and “negative” deviation−δmax lines may represent a maximum allowable deviation δₘₐₓ.

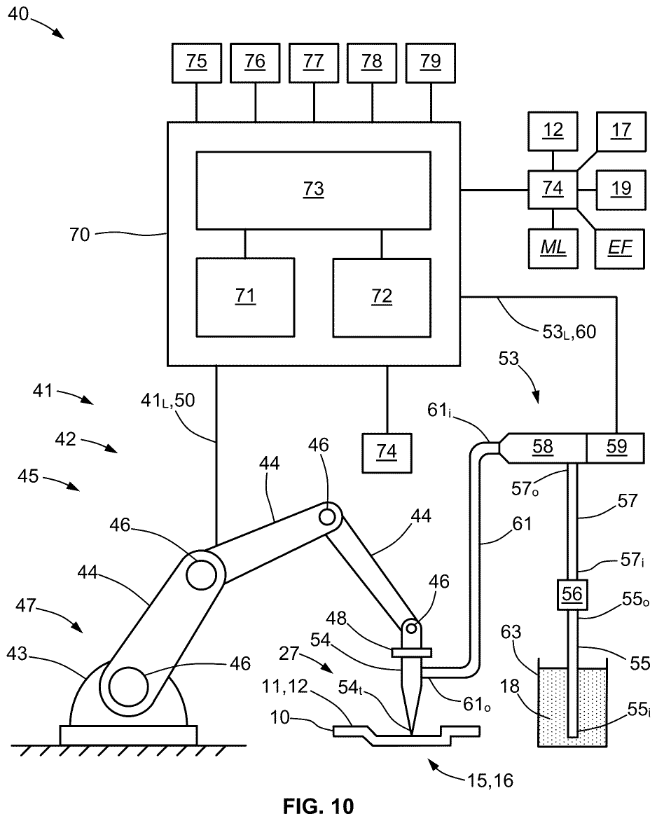

FIG. 10 shows an IRDS 40 for dispensing a bead 26 of viscous material 18 onto a workpiece 10 according to a bead layout pattern 27. The IRDS 40 includes a robot subsystem 41, a dispensing subsystem 53 and a control subsystem 70.

The robot subsystem 41 includes a robot 42 having a base 43 and a collection or series 45 of one or more articulatable arms 44, with the arms 44 being connected to each other in serial fashion via one or more articulating joints 46. The series 45 of arms 44 has a base end 47 attached to the base 43 and a working end 48 opposite the base end 47. The arms 44 and joints 46 are configured to cooperate with each other such that the arms 44 and the working end 48 may be moved into various positions 51 and orientations 52. The working end 48 may include a mounting plate or other mechanism configured for securing one or more devices thereto.

The dispensing subsystem 53 includes a dispenser 54 which may be operatively attached to the working end 48 of the robot 42. The dispenser 54 may be operatively connected with a chamber 58 which acts as a receptacle or container of the viscous material 18, such that the dispenser tip 54ₜ is in fluid communication with the chamber 58. The dispenser 54 has a dispenser tip 54ₜ which is configured to selectably dispense the viscous material 18 therefrom and onto one or more surfaces 11 of a workpiece 10, such as by the urging of a metering device 59 which is operatively connected with the dispenser 54 and/or chamber 58. The metering device 59 may assume various forms, including a plunger or piston that is mechanically, electromechanically, hydraulically or pneumatically driven so as to control the dispensing of viscous material 18 from the dispenser tip 54ₜ.

The dispensing subsystem 53 may also include an inlet hose or conduit 55, which has an inlet end 55ᵢ (e.g., for insertion into a drum or source 63 of viscous material 18) and an outlet end 55ₒ. Optionally, the dispensing subsystem 53 may include a material reconditioner 56 which is attached to the outlet end 55ₒ of the inlet conduit 55 (for receiving the viscous material 18) and to an inlet end 57ᵢ of a transfer hose or conduit 57 which also has an outlet end 57ₒ. The material reconditioner 56 may be configured for altering a material property 19 of the viscous material 18. For example, the material property 19 may be viscosity μ, and the material reconditioner 56 may be configured for applying shear to the viscous material 18 so as to reduce the viscosity μthereof. The outlet end 57ₒ of the transfer conduit 57 may be operatively connected with the chamber 58 or metering device 59, and an optional outlet hose or conduit 61 may operatively connect the chamber/metering device 58, 59 with the dispenser 54. For example, an inlet end 61ᵢ of the conduit 61 may be operatively connected with the chamber/metering device 58, 59 and an outlet end 61ₒ of the conduit 61 may be operatively connected with the dispenser 54.

In some configurations, the viscous material 18 may be drawn from an external source 63 and conveyed through the inlet conduit 55, the material reconditioner 56, and the transfer conduit 57 and into the chamber/metering device 58, 59, and then pushed through the outlet conduit 61 to the dispenser 54 and then out the dispenser tip 54ₜ and onto a workpiece 10. In other configurations, such as when the dispenser 54 is configured for dispensing a viscous material 18 such as a molten metal or solder, the chamber 58 may be a heated container for containing liquid molten solid metal/solder which is dispensed by the dispenser 54, or the chamber 58 may store solid metal/solder (e.g., in wire or powder form) which is melted immediately before or after being dispensed by the dispenser 54, such as by a laser, an inductive heater, a conductive heater or some other heating device. In yet other configurations, the dispensing subsystem 53 does not include any inlet conduit 55, transfer conduit 57 or outlet conduit 61, with the viscous material 18 being loaded directly into the chamber/metering device 58, 59, and with the chamber/metering device 58, 59 being directly connected with the dispenser 54. Multiple different configurations are possible.

The control subsystem 70 includes a robot subsystem control module 71 operatively connected with the robot subsystem 41 for moving and positioning the one or more arms 44 and the working end 48 according to a motion profile 50, a dispensing subsystem control module 72 operatively connected with the dispensing subsystem 53 for controlling the dispensing of the viscous material 18 by the dispenser 54 according to a dispense profile 60, and a central control module 73 operatively connected with the robot subsystem control module 71 and the dispensing subsystem control module 72. The central control module 73 is configured for determining the motion profile 50 and the dispense profile 60 and for causing the robot subsystem 41 to be moved and positioned according to the motion profile 50 and the dispensing subsystem 53 to dispense the viscous material 18 according to the dispense profile 60 to form a dispensed bead 26. The robot subsystem 41 and the dispensing subsystem 53 are configured to cooperate with each other so as to minimize any deviation δ between the bead layout pattern 27 and the dispensed bead 26.

The IRDS 40 may further include one or more sensors 74 (e.g., machine vision cameras, pressure/force transducers, flow meters, thermometers, thermistors, encoders, etc.) that are operatively connected with the control subsystem 70, (e.g., directly or indirectly connected with the central control module 73). Such sensors 74 may be configured for sensing and monitoring any deviation δ between the bead layout pattern 27 and the dispensed bead 26, as well as for sensing and monitoring other factors such as the material properties 19 of the viscous material 18, the material properties 17 and geometric/surface features 12 of the workpiece 10, various environmental factors EF (e.g., the ambient temperature, barometric pressure and humidity around the IRDS 40), etc. In some arrangements, the one or more sensors 74 may include one or more input/output devices (e.g., input connectors, output connectors, data busses, data conditioners, signal wires, etc.) that are configured for receiving data and information, such as limitations 41_{L} of the robot subsystem 41 (received from the robot subsystem 41), limitations 53_{L} of the dispensing subsystem 53 (received from the dispensing subsystem 53), and information derived from machine learning ML that is based on data D relating to previous instances PI of dispensing the viscous material 18, etc.

The central control module 73 may be further configured to modify one or both of the motion profile 50 and the dispense profile 60 when the deviation δ between the bead layout pattern 27 and the dispensed bead 26 is larger than a maximum allowable deviation δₘₐₓ. For example, if data received from a sensor 74 (such as a machine vision camera) indicates that the deviation δ is larger than the maximum allowable deviation δₘₐₓ, then the central control module 73 may cause the motion profile 50 to be modified momentarily so as to speed up the movement of the working end 48 (and thus also the dispenser 54 which is attached to the working end 48), or cause the dispense profile 60 to be modified momentarily so as to reduce the dispense flow rate 66, or cause both the motion profile 50 and the dispense profile 60 to be modified momentarily, until the deviation δ is reduced to less than or equal to the maximum allowable deviation δₘₐₓ, which may be confirmed by the sensor(s) 74. Note that while FIG. 10 shows two input/output lines or devices—i.e., one connected with the robot subsystem 41 for receiving the limitations 41_{L} of the robot subsystem 41 and for transmitting the motion profile 50 to the robot subsystem 41, and the other connected with the metering device 59 of the dispense subsystem 53 for receiving the limitations 53_{L} of the dispense subsystem 53 and for transmitting the dispense profile 60 to the dispense subsystem 53—it should be noted that there may be more than two input/output lines or devices, which optionally may be connected with other parts of the subsystems 41, 53. Further, the limitations 41_{L}, 53_{L} of the robot and dispense subsystems 41, 53 may include information relating to each respective subsystem's state-of-health, lag times in response to commands, level of viscous material 18 within the drum/source 63, amount and/or pressure of the viscous material 18 within the chamber 58, etc.

As shown in FIG. 10, the IRDS 40 may also include input/output lines or devices connected with one or more peripheral subsystems, such as various welding equipment 75, one or more autonomous guided carts (AGCs) 76, one or more conveyors 77, various pick-and-place equipment 78, as well as other equipment 79 (such as for moving, holding and orienting the workpiece 10). The control subsystem 70 may receive inputs (e.g., data and information) from such peripheral subsystems, as well as send outputs (e.g., commands, adjustments) to such peripheral subsystems.

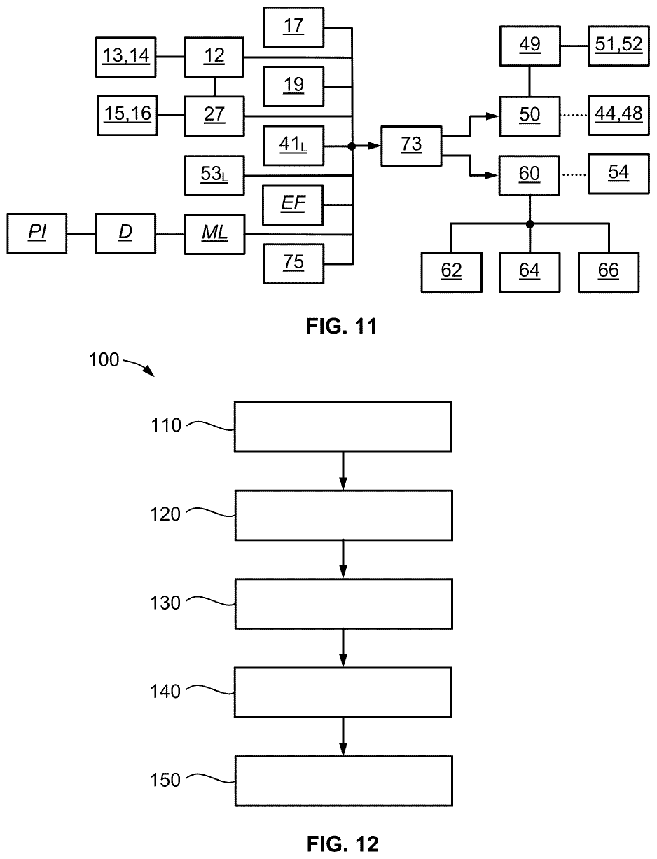

FIG. 11 shows a block diagram of inputs into the central control module 73 for producing a motion profile 50 and a dispense profile 60. The central control module 73 may determine the motion profile 50 and the dispense profile 60 based on various factors, such as the bead layout pattern 27 and one or more of: (i) one or more material properties 19 of the viscous material 18; (ii) one or more material properties 17 of the workpiece 10; (iii) one or more geometric or surface features 12 of the workpiece 10; (iv) one or more limitations 41_{L} of the robot subsystem 41; (v) one or more limitations 53_{L} of the dispensing subsystem 53; (vi) one or more environmental factors EF; and (vii) machine learning ML based on data D relating to previous instances PI of dispensing the viscous material 18.

The central control module 73 may be further configured to modify one or both of the motion profile 50 and the dispense profile 60 on-the-fly in order to cause the dispensed bead 26 to conform with the bead layout pattern 27. Additionally, at least one of the motion profile 50 and the dispense profile 60 may be modified due to a direction change 38 in the bead layout pattern 27.

The motion profile 50 may define one or more motions 49 for the working end 48 and/or for the one or more arms 44, for achieving a respective position 51 and orientation 52, versus time, for the working end 48 and/or the one or more arms 44. Relatedly, the dispense profile 60 may define one or more dispense starts 62, one or more dispense stops 64 and one or more dispense flow rates 66, versus time, for the dispensing of the viscous material 18 by the dispenser 54.

FIG. 12 shows a flowchart for a method 100 for dispensing a bead 26 of viscous material 18 onto a workpiece 10 according to a bead layout pattern 27. At block 110, an IRDS 40 is provided which includes a robot 42 having a base 43 and a series 45 of one or more articulatable arms 44, where the series 45 of arms 44 has a base end 47 attached to the base 43 and a working end 48 opposite the base end 47. The IRDS 40 also includes a dispenser 54 operatively attached to the working end 48 and configured to selectably dispense the viscous material 18 from a dispenser tip 54ₜ. The IRDS 40 further includes a control subsystem 70 for moving and positioning the one or more arms 44 and the working end 48 according to a motion profile 50, and for controlling the dispensing of the viscous material 18 by the dispenser 54 according to a dispense profile 60.

At block 120, the motion profile 50 and the dispense profile 60 are determined by the control subsystem 70 based on the bead layout pattern 27. At block 130, the robot 42 is moved and positioned according to the motion profile 50, and the dispenser 54 is caused to dispense the viscous material 18 according to the dispense profile 60 to form a dispensed bead 26. At block 140, a deviation δ between the dispensed bead 26 and the bead layout pattern 27 is monitored, such as by one or more sensors 74 that are connected with the control subsystem70. And at block 150, one or both of the motion profile 50 and the dispense profile 60 are modified when the deviation δ is larger than a maximum allowable deviation δₘₐₓ.

As one having skill in the relevant art will appreciate, the integrated robotic dispense system 40 and method 100 of the present disclosure may be presented or arranged in a variety of different configurations and embodiments.

According to one embodiment, an integrated robotic dispense system 40 for dispensing a bead 26 of viscous material 18 onto a workpiece 10 according to a bead layout pattern 27 includes: (i) a robot subsystem 41 which includes a robot 42, wherein the robot 42 has a base 43 and a series 45 of one or more articulatable arms 44 having a base end 47 attached to the base 43 and a working end 48 opposite the base end 47; (ii) a dispensing subsystem 53 which includes a dispenser 54 operatively attached to the working end 48 and configured to selectably dispense the viscous material 18 from a dispenser tip 54ₜ; and (iii) a control subsystem 70 which includes a robot subsystem control module 71 operatively connected with the robot subsystem 41 for moving and positioning the one or more arms 44 and the working end 48 according to a motion profile 50, a dispensing subsystem control module 72 operatively connected with the dispensing subsystem 53 for controlling the dispensing of the viscous material 18 by the dispenser 54 according to a dispense profile 60, and a central control module 73 operatively connected with the robot subsystem control module 71 and the dispensing subsystem control module 72. The central control module 73 is configured for determining the motion profile 50 and the dispense profile 60 and for causing the robot subsystem 41 to be moved and positioned according to the motion profile 50 and the dispensing subsystem 53 to dispense the viscous material 18 according to the dispense profile 60 to form a dispensed bead 26, such that a deviation δ is minimized between the dispensed bead 26 and the bead layout pattern 27.

The central control module 73 may determine the motion profile 50 and the dispense profile 60 based on the bead layout pattern 27 and one or more of: one or more material properties 19 of the viscous material 18; one or more material properties 17 of the workpiece 10; one or more geometric or surface features 12 of the workpiece 10; one or more limitations 41_{L} of the robot subsystem 41; one or more limitations 53_{L} of the dispensing subsystem 53; one or more environmental factors EF; and machine learning ML based on data D relating to previous instances PI of dispensing the viscous material 18. The central control module 73 may be further configured to modify one or both of the motion profile 50 and the dispense profile 60 in order to cause the dispensed bead 26 to conform with the bead layout pattern 27. Additionally, at least one of the motion profile 50 and the dispense profile 60 may be modified due to a direction change 38 in the bead layout pattern 27.

The integrated robotic dispense system 40 may further include one or more sensors 74 for monitoring the deviation δ between the dispensed bead 26 and the bead layout pattern 27, and the central control module 73 may be further configured to modify one or both of the motion profile 50 and the dispense profile 60 when the deviation δ is larger than a maximum allowable deviation δₘₐₓ.

The dispensing subsystem 53 may further include a chamber 58 for containing the viscous material 18, and the dispenser tip 54ₜ may be in fluid communication with the chamber 58.

The dispensing subsystem 53 may further include a material reconditioner 56 configured for altering a material property 19 of the viscous material 18. The material property 19 may be viscosity μ, and the material reconditioner 56 may be configured for applying shear to the viscous material 18 so as to reduce the viscosity μ thereof.

The viscous material 18 may be one of an adhesive 21, a sealant 22, a mastic 23 and a molten metal 24.

The motion profile 50 may define one or more motions 49 for one or more of the working end 48 and the one or more arms 44 for achieving a respective position 51 and orientation 52 for the one or more of the working end 48 and the one or more arms 44, and the dispense profile 60 may define one or more dispense starts 62, one or more dispense stops 64 and one or more dispense flow rates 66 for the dispensing of the viscous material 18 by the dispenser 54.

The bead layout pattern 27 may be defined with respect to a spatial position 15 and a spatial orientation 16 of the workpiece 10. Additionally or alternatively, the bead layout pattern 27 may be defined with respect to one or more surface features 12 of the workpiece 10.

The bead layout pattern 27 includes one or more of: a respective start point 29, stop point 30 and straight path 31 for each of one or more straight bead segments 28; a respective begin point 33, end point 34 and curved path 35 for each of one or more curved bead segments 32; and a respective bead width 36 for every point 37 along each of the one or more straight bead segments 28 and each of the one or more curved bead segments 32.

According to another embodiment, an integrated robotic dispense system 40 for dispensing a bead 26 of viscous material 18 onto a workpiece 10 according to a bead layout pattern 27 includes: (i) a robot subsystem 41 which includes a robot 42, wherein the robot 42 has a base 43 and a series 45 of one or more articulatable arms 44 having a base end 47 attached to the base 43 and a working end 48 opposite the base end 47; (ii) a dispensing subsystem 53 which includes a dispenser 54 operatively attached to the working end 48 and configured to selectably dispense the viscous material 18 from a dispenser tip 54ₜ; and (iii) a control subsystem 70 which includes a robot subsystem control module 71 operatively connected with the robot subsystem 41 for moving and positioning the one or more arms 44 and the working end 48 according to a motion profile 50, a dispensing subsystem control module 72 operatively connected with the dispensing subsystem 53 for controlling the dispensing of the viscous material 18 by the dispenser 54 according to a dispense profile 60, and a central control module 73 operatively connected with the robot subsystem control module 71 and the dispensing subsystem control module 72. The central control module 73 is configured for: (a) determining the motion profile 50 and the dispense profile 60 based on the bead layout pattern 27; (b) causing the robot subsystem 41 to be moved and positioned according to the motion profile 50 and the dispensing subsystem 53 to dispense the viscous material 18 according to the dispense profile 60 to form a dispensed bead 26, such that the robot subsystem 41 and the dispensing subsystem 53 cooperate together to minimize a deviation δ between the dispensed bead 26 and the bead layout pattern 27; and (c) modifying one or both of the motion profile 50 and the dispense profile 60 when the deviation δ is larger than a maximum allowable deviation δₘₐₓ.

In this embodiment, the central control module 73 may determine the motion profile 50 and the dispense profile 60 based further on one or more of: one or more material properties 19 of the viscous material 18; one or more material properties 19 of the workpiece 10; one or more geometric or surface features 12 of the workpiece 10; one or more limitations 41_{L} of the robot subsystem 41; one or more limitations 53_{L} of the dispensing subsystem 53; one or more environmental factors EF; and machine learning ML based on data D relating to previous instances PI of dispensing the viscous material 18.

In this embodiment, at least one of the motion profile 50 and the dispense profile 60 may be modified due to a direction change 38 in the bead layout pattern 27.

In this embodiment, the integrated robotic dispense system 40 may further include one or more sensors 74 for monitoring the deviation δ between the dispensed bead 26 and the bead layout pattern 27.

In this embodiment, the dispensing subsystem 53 may further include a material reconditioner 56 configured for altering a viscosity μof the viscous material 18.

In this embodiment, the motion profile 50 may define one or more motions 49 for one or more of the working end 48 and the one or more arms 44 for achieving a respective position 51 and orientation 52 for the one or more of the working end 48 and the one or more arms 44, and the dispense profile 60 may define one or more dispense starts 62, one or more dispense stops 64 and one or more dispense flow rates 66, for the dispensing of the viscous material 18 by the dispenser 54.

According to yet another embodiment, a method 100 for dispensing a bead 26 of viscous material 18 onto a workpiece 10 according to a bead layout pattern 27 includes: (i) at block 110, providing an integrated robotic dispense system 40 which includes a robot 42 having a base 43 and a series 45 of one or more articulatable arms 44 having a base end 47 attached to the base 43 and a working end 48 opposite the base end 47, a dispenser 54 operatively attached to the working end 48 and configured to selectably dispense the viscous material 18 from a dispenser tip 54ₜ, and a control subsystem 70 for moving and positioning the one or more arms 44 and the working end 48 according to a motion profile 50 and controlling the dispensing of the viscous material 18 by the dispenser 54 according to a dispense profile 60; (ii) at block 120, determining, by the control subsystem 70, the motion profile 50 and the dispense profile 60 based on the bead layout pattern 27; (iii) at block 130, causing the robot 42 to be moved and positioned according to the motion profile 50 and the dispenser 54 to dispense the viscous material 18 according to the dispense profile 60 to form a dispensed bead 26; (iv) at block 140, monitoring a deviation δ between the dispensed bead 26 and the bead layout pattern 27; and (v) at block 150, modifying one or both of the motion profile 50 and the dispense profile 60 when the deviation δ is larger than a maximum allowable deviation δₘₐₓ.

While various steps of the method 100 have been described as being separate blocks, and various functions of the integrated robotic dispense system 40 have been described as being separate modules or elements, it may be noted that two or more steps may be combined into fewer blocks, and two or more functions may be combined into fewer modules or elements. Similarly, some steps described as a single block may be separated into two or more blocks, and some functions described as a single module or element may be separated into two or more modules or elements. Additionally, the order of the steps or blocks described herein may be rearranged in one or more different orders, and the arrangement of the functions, modules and elements may be rearranged into one or more different arrangements.

(As used herein, a “module” may include hardware and/or software, including executable instructions, for receiving one or more inputs, processing the one or more inputs, and providing one or more corresponding outputs. Also note that at some points throughout the present disclosure, reference may be made to a singular input, output, element, etc., while at other points reference may be made to plural/multiple inputs, outputs, elements, etc. Thus, weight should not be given to whether the input(s), output(s), element(s), etc. are used in the singular or plural form at any particular point in the present disclosure, as the singular and plural uses of such words should be viewed as being interchangeable, unless the specific context dictates otherwise.)

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. An integrated robotic dispense system for dispensing a bead of viscous material onto a workpiece according to a bead layout pattern, comprising:
a robot subsystem which includes a robot, wherein the robot has a base and a series of one or more articulatable arms having a base end attached to the base and a working end opposite the base end;
a dispensing subsystem which includes a dispenser operatively attached to the working end and configured to selectably dispense the viscous material from a dispenser tip; and
a control subsystem which includes a robot subsystem control module operatively connected with the robot subsystem for moving and positioning the one or more arms and the working end according to a motion profile, a dispensing subsystem control module operatively connected with the dispensing subsystem for controlling the dispensing of the viscous material by the dispenser according to a dispense profile, and a central control module operatively connected with the robot subsystem control module and the dispensing subsystem control module;
wherein the central control module is configured for determining the motion profile and the dispense profile and for causing the robot subsystem to be moved and positioned according to the motion profile and the dispensing subsystem to dispense the viscous material according to the dispense profile to form a dispensed bead, such that a deviation is minimized between the dispensed bead and the bead layout pattern.

2. The integrated robotic dispense system of claim 1, wherein the central control module determines the motion profile and the dispense profile based on the bead layout pattern and one or more of:
one or more material properties of the viscous material;
one or more material properties of the workpiece;
one or more geometric or surface features of the workpiece;
one or more limitations of the robot subsystem;
one or more limitations of the dispensing subsystem;
one or more environmental factors; and
machine learning based on data relating to previous instances of dispensing the viscous material.

3. The integrated robotic dispense system of claim 2, wherein the central control module is further configured to modify one or both of the motion profile and the dispense profile in order to cause the bead to conform with the bead layout pattern.

4. The integrated robotic dispense system of claim 3, wherein at least one of the motion profile and the dispense profile is modified due to a direction change in the bead layout pattern.

5. The integrated robotic dispense system of claim 1, further including one or more sensors for monitoring the deviation between the bead layout pattern and the dispensed bead, wherein the central control module is further configured to modify one or both of the motion profile and the dispense profile when the deviation is larger than a maximum allowable deviation.

6. The integrated robotic dispense system of claim 1, wherein the dispensing subsystem further includes a chamber for containing the viscous material, and wherein the dispenser tip is in fluid communication with the chamber.

7. The integrated robotic dispense system of claim 1, wherein the dispensing subsystem further includes a material reconditioner configured for altering a material property of the viscous material.

8. The integrated robotic dispense system of claim 7, wherein the material property is viscosity, and wherein the material reconditioner is configured for applying shear to the viscous material so as to reduce the viscosity thereof.

9. The integrated robotic dispense system of claim 1, wherein the viscous material is one of an adhesive, a sealant, a mastic and a molten metal.

10. The integrated robotic dispense system of claim 1, wherein the motion profile defines one or more motions for one or more of the working end and the one or more arms for achieving a respective position and orientation for the one or more of the working end and the one or more arms; and
wherein the dispense profile defines one or more dispense starts, one or more dispense stops and one or more dispense flow rates for the dispensing of the viscous material by the dispenser.

11. The integrated robotic dispense system of claim 1, wherein the bead layout pattern is defined with respect to a spatial position and a spatial orientation of the workpiece.

12. The integrated robotic dispense system of claim 1, wherein the bead layout pattern is defined with respect to one or more surface features of the workpiece.

13. The integrated robotic dispense system of claim 1, wherein the bead layout pattern includes one or more of:
a respective start point, stop point and straight path for each of one or more straight bead segments;
a respective begin point, end point and curved path for each of one or more curved bead segments; and
a respective bead width for every point along each of the one or more straight bead segments and each of the one or more curved bead segments.

14. An integrated robotic dispense system for dispensing a bead of viscous material onto a workpiece according to a bead layout pattern, comprising:
a robot subsystem which includes a robot, wherein the robot has a base and a series of one or more articulatable arms having a base end attached to the base and a working end opposite the base end;
a dispensing subsystem which includes a dispenser operatively attached to the working end and configured to selectably dispense the viscous material from a dispenser tip; and
a control subsystem which includes a robot subsystem control module operatively connected with the robot subsystem for moving and positioning the one or more arms and the working end according to a motion profile, a dispensing subsystem control module operatively connected with the dispensing subsystem for controlling the dispensing of the viscous material by the dispenser according to a dispense profile, and a central control module operatively connected with the robot subsystem control module and the dispensing subsystem control module;
wherein the central control module is configured for:
determining the motion profile and the dispense profile based on the bead layout pattern;
causing the robot subsystem to be moved and positioned according to the motion profile and the dispensing subsystem to dispense the viscous material according to the dispense profile to form a dispensed bead, such that the robot subsystem and the dispensing subsystem cooperate together to minimize a deviation between the bead layout pattern and the dispensed bead; and
modifying one or both of the motion profile and the dispense profile when the deviation is larger than a maximum allowable deviation.

15. The integrated robotic dispense system of claim 14, wherein the central control module determines the motion profile and the dispense profile based further on one or more of:
one or more material properties of the viscous material;
one or more material properties of the workpiece;
one or more geometric or surface features of the workpiece;
one or more limitations of the robot subsystem;
one or more limitations of the dispensing subsystem;
one or more environmental factors; and
machine learning based on data relating to previous instances of dispensing the viscous material.

16. The integrated robotic dispense system of claim 14, wherein at least one of the motion profile and the dispense profile is modified due to a direction change in the bead layout pattern.

17. The integrated robotic dispense system of claim 14, further including one or more sensors for monitoring the deviation between the bead layout pattern and the dispensed bead.

18. The integrated robotic dispense system of claim 14, wherein the dispensing subsystem further includes a material reconditioner configured for altering a viscosity of the viscous material.

19. The integrated robotic dispense system of claim 14, wherein the motion profile defines one or more motions for one or more of the working end and the one or more arms for achieving a respective position and orientation, for the one or more of the working end and the one or more arms; and
wherein the dispense profile defines one or more dispense starts, one or more dispense stops and one or more dispense flow rates, for the dispensing of the viscous material by the dispenser.

20. A method for dispensing a bead of viscous material onto a workpiece according to a bead layout pattern, comprising:
providing an integrated robotic dispense system which includes a robot having a base and a series of one or more articulatable arms having a base end attached to the base and a working end opposite the base end, a dispenser operatively attached to the working end and configured to selectably dispense the viscous material from a dispenser tip, and a control subsystem for moving and positioning the one or more arms and the working end according to a motion profile and controlling the dispensing of the viscous material by the dispenser according to a dispense profile;
determining, by the control subsystem, the motion profile and the dispense profile based on the bead layout pattern;
causing the robot to be moved and positioned according to the motion profile and the dispenser to dispense the viscous material according to the dispense profile to form a dispensed bead;
monitoring a deviation between the bead layout pattern and the dispensed bead; and
modifying one or both of the motion profile and the dispense profile when the deviation is larger than a maximum allowable deviation.
